(19) United States
(12) Patent Application Publication
(10) Pub. No.: US 2018/0101661 A1
(43) Pub. Date: Apr. 12, 2018

(54) System and Method for Collecting Medical Data

(71) Applicant: Veeva Systems Inc., Pleasanton, CA (US)

(72) Inventors: Brian Longo, Danville, CA (US); Abhay Pimprikar, Campbell, CA (US)

(73) Assignee: Veeva Systems Inc., Pleasanton, CA (US)

(21) Appl. No.: 15/420,999

(22) Filed: Jan. 31, 2017

Related U.S. Application Data
(63) Continuation-in-part of application No. 15/414,484, filed on Jan. 24, 2017, now abandoned.
(60) Provisional application No. 62/407,399, filed on Oct. 12, 2016.

(51) Int. Cl. G06F 19/00

(52) U.S. Cl. CPC G06F 19/363

(57) ABSTRACT

Systems and methods for collecting medical data which may allow a sponsor to receive EDC data from one or more clinical trial sites. A definition of a clinical trial may be generated by a sponsor and published to the one or more clinical sites. The definition of the clinical trial may define requirements and the workflow of a clinical trial. A medical data management system may determine the EDC data requirements in the definition of the clinical trial, including required clinical trial source data for generating the EDC data. The medical data management system may identify data in the clinical trial source data that matches the required source data, process the matching source data according to the EDC data requirements to generate the EDC data, and send the EDC data to the sponsor data management system.

### CROSS-REFERENCE TO RELATED APPLICATION

This application relates and claims priority to provisional patent application No. 62/407,399, filed on Oct. 12, 2016, entitled System and Method for Collecting Medical Data, and is a continuation-in-part of non-provisional patent application Ser. No. 15/414,484, filed on Jan. 24, 2017, entitled System and Method for Collecting Medical Data. Both prior applications are hereby incorporated by reference herein for all purposes.

### BACKGROUND

The subject technology relates generally to medical data management, and more particularly to collecting clinical trial data.

Clinical trials are research studies on participants designed to answer specific questions about biomedical or behavioral interventions, including new treatments (such as drugs and medical devices). A clinical trial may involve a sponsor, which may be a governmental organization, or a pharmaceutical, medical device, or biotechnology company, and one or more clinical sites. Traditionally, patient clinical trial source data are captured on paper at clinical sites. The documents are collected by a sponsor, and the clinical trial source data may then be imported to an electronic data capture (EDC) system, which is a system usually owned by a sponsor and designed for the collection of clinical data in electronic format. It is desirable to improve efficiency of the process for collecting clinical trial data.

### SUMMARY

A method for collecting medical data comprises: receiving a definition of a first clinical trial from a sponsor data management system, wherein the definition of the first clinical trial defines requirements and a workflow of the first clinical trial. The method further comprises: receiving clinical trial source data from a site data management system, wherein the clinical trial source data is collected according to the definition of the first clinical trial. The method further comprises: determining EDC data requirements in the definition of the first clinical trial, including required source data for generating the EDC data; identifying data in the clinical trial source data that matches the required source data; and processing the matching source data according to the EDC data requirements to generate the EDC data.

### BRIEF DESCRIPTION OF THE DRAWINGS

FIG. 1 illustrates an example high level block diagram of a medical data management architecture wherein the present invention may be implemented.

FIGS. 2A to 2E illustrate example user interfaces for creating or editing a study design according to one embodiment of the present invention.

FIGS. 3A to 3D illustrate example user interfaces for collecting patient clinical trial source data according to one embodiment of the present invention.

FIG. 4 illustrates an example flowchart of a method for collecting medical data according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

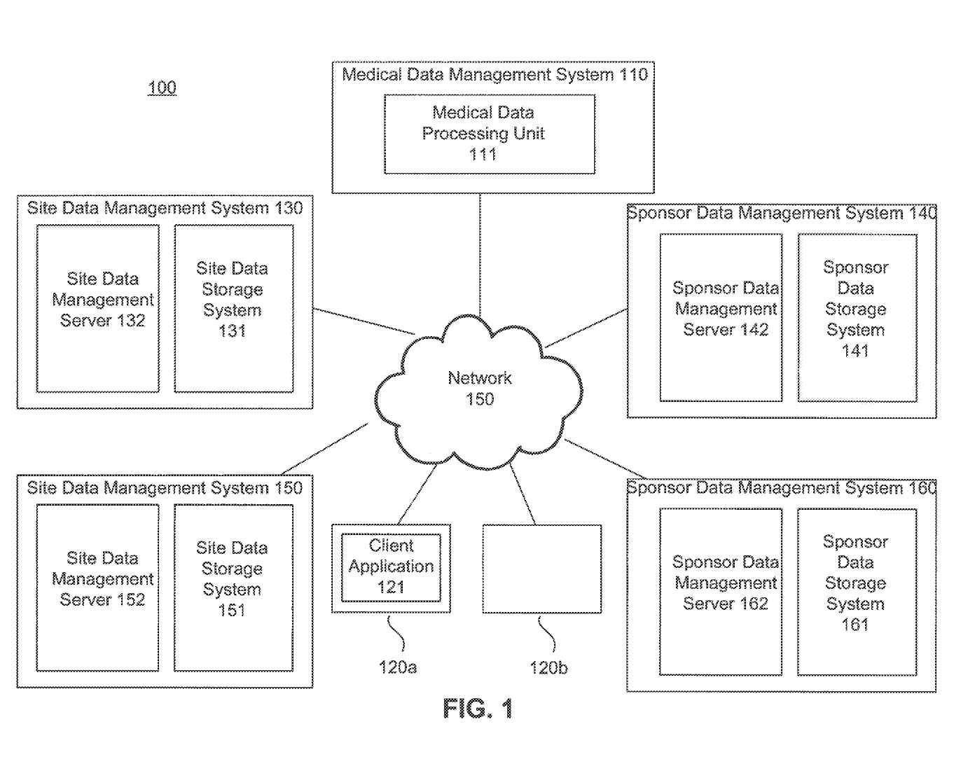

FIG. 1 illustrates an example high level block diagram of a medical data management architecture 100 wherein the present invention may be implemented. As shown, the architecture 100 may include a medical data management system 110, one or more site data management systems (e.g., 130 and 150), and one or more sponsor data management systems (e.g., 140 and 160) coupled to each other over a network. The architecture 100 may also include one or more user computing devices (e.g., 120a) coupled to one of the site data management systems (e.g., 130) over the network, and one or more user computing devices (e.g., 120b) coupled to one of the sponsor data management systems (e.g., 140) over the network. The network may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The first sponsor data management system 140 may include a sponsor data storage system 141 and a sponsor data management server 142. The sponsor data management server 142 may display a user interface for receiving definition of a clinical trial, and the sponsor data storage system 141 may store EDC data and the definition of a clinical trial.

The first site data management system 130 may include a site data storage system 131 and a site data management server 132. The site data management server 132 may communicate with the user computing device 120a to receive clinical trial source data, and the site data storage system 131 may store the clinical trial source data.

The medical data management system 110 may receive the definition of a first clinical trial from a sponsor data management system (e.g., 140), and identify the EDC data requirements of the first clinical trial (e.g., a patient's blood pressure values over six weeks, with three values each week, and each value is the average of three measurements taken during one visit). The medical data management system 110 may determine that a first clinical trial site is participating in the first clinical trial, and receive the clinical trial source data from the first site data management system 130. The medical data management system 110 may process the clinical trial source data from the first site data management system 130 according to the EDC data requirements of the first clinical trial to obtain the EDC data, and send the EDC data to the first sponsor data management system 140. In one implementation, only aggregated and obfuscated data, without patient defining information, is sent to the sponsor repository 111a and stored there as the EDC data.

The medical data management system 110 may determine that a second clinical trial site is participating in the first clinical trial, and receive the clinical trial source data from the second site data management system 150. The medical data management system 110 may process the clinical trial source data from the second site data management system 150 according to the EDC data requirements of the first clinical trial to obtain the EDC data, and send the EDC data to the first sponsor data management system 140. The medical data management system 110 may include a medical data processing unit 111 for processing the clinical trial source data. The medical data management system 110 may also have storage units for temporarily storing the clinical trial source data and the EDC data.

In one implementation, the medical data management system 110 is a middleware layer between the site data management system 130 and the sponsor data management system 140. In one implementation, the medical data management system 110 is an integration engine.

The user computing devices 120a and 120b may be any machine or system that is used by a user to access the site data management systems (e.g., 130 or 150) or the sponsor data management systems (e.g., 140 or 160) via the network 150, and may be any commercially available computing devices including laptop computers, desktop computers, mobile phones, smart phones, tablet computers, netbooks, and personal digital assistants (PDAs). A client application 121 may run from a user computing device, e.g., 120a, to communicate with the first site data management system 130, send clinical trial source data to the first site data management system 130 and access data stored in the site data storage system 131. A user computing device 120b may communicate with the first sponsor data management system 140, input definition of the first clinical trial, and access data in the sponsor data storage system 141.

In one implementation, the architecture 100 may be used for collecting and managing medical data, e.g., clinical trial data. The sponsor data storage system 141 may be used by a first sponsor (e.g., a pharmaceutical company) to store a first study design received from a first user computing device (e.g., 120b). The first study design may define the infrastructure and lifecycle of the study, and may comprise rules (e.g., for queries, derived values, notifications and displaying events, forms and items), a casebook (i.e., a doctor's binder), event groups, events (e.g., patients visits), forms which comprise segregate sections and fields, item groups and items. In one example, a study design may define a particular study, i.e., each patient may have ten visits, and each visit may have three forms. There may be a workflow associated with each visit, e.g., what needs to be done at each visit.

In one implementation, the first study design may be stored as definition objects in the sponsor data storage system 141, specifying what is required to happen on each site during the study and also requirements for the EDC data. The sponsor data storage system 141 may also store electronic records of the first study received from the medical data management system 110. In one implementation, the electronic records may be EDC data. Patient clinical trial source data may be captured at the site data management system 130, and processed to obtain EDC data by the medical data management system 110, and stored in the sponsor data storage system 141.

The site data storage system 131 may be used by a first site (e.g., a hospital) of the first study to store clinical trial source data from a user computing device (e.g., 120a), and a site data storage system 151 may be used by a second site of the first study to store clinical trial source data from a user computing device. The clinical trial source data (e.g., three blood pressure values of a patient taken during one visit) in the site data storage systems may be converted to EDC data (e.g., the average of the three blood pressure values) by the medical data management system 110, and then stored in the sponsor data storage system 141 as EDC data. The first study design may be transmitted to the site data management systems 130 and 150 from the sponsor data management system 140 via the medical data management system 110.

In one implementation, the medical data management system 110 may be a multi-tenant system where various elements of hardware and software may be shared by one or more customers. For instance, the medical data processing unit 111 may simultaneously process requests from a plurality of customers, including sponsors or clinical trial sites. In a multi-tenant system, a user is typically associated with a particular customer. In one example, a user could be an employee of one of a number of pharmaceutical companies or clinical trial sites which are tenants, or customers, of the medical data management system 110.

In one embodiment, the medical data management system 110 may run on a cloud computing platform.

In one embodiment, the medical data management system 110 may be provided as Software as a Service (“SaaS”).

A sponsor user may design a clinical study via the sponsor data management server 142 and store the study design as definition objects in the sponsor data storage system 141. A study design may have multiple elements, including a casebook, groups, events (e.g., patient visits), and forms which include sections, item groups, items, and fields to be filled out.

In one example, a clinical trial is designed to evaluate patient response to a blood pressure medication. Participants on the medication may visit a clinical trial site three times a week for consecutive six weeks. A workflow may be designed for each visit, and may include forms to be filled out, and measurements to be taken. In one example, a participant's blood pressure may be measured three times during each visit, stored in the site data storage system 131 as clinical trial source data.

A study design may have its own lifecycle. Once a sponsor completes a study design, a workflow may be executed to publish the study design to the participating clinical trial sites (e.g., by sending the study design to site data management systems 130 and 150 via the medical data management system 110) and the clinical trial may enter its execution stage. If the study design is amended during the execution stage, the updates may be sent to the participating clinical trial sites (e.g., by sending the updates down to the site data management systems 130 and 150) for them to follow.

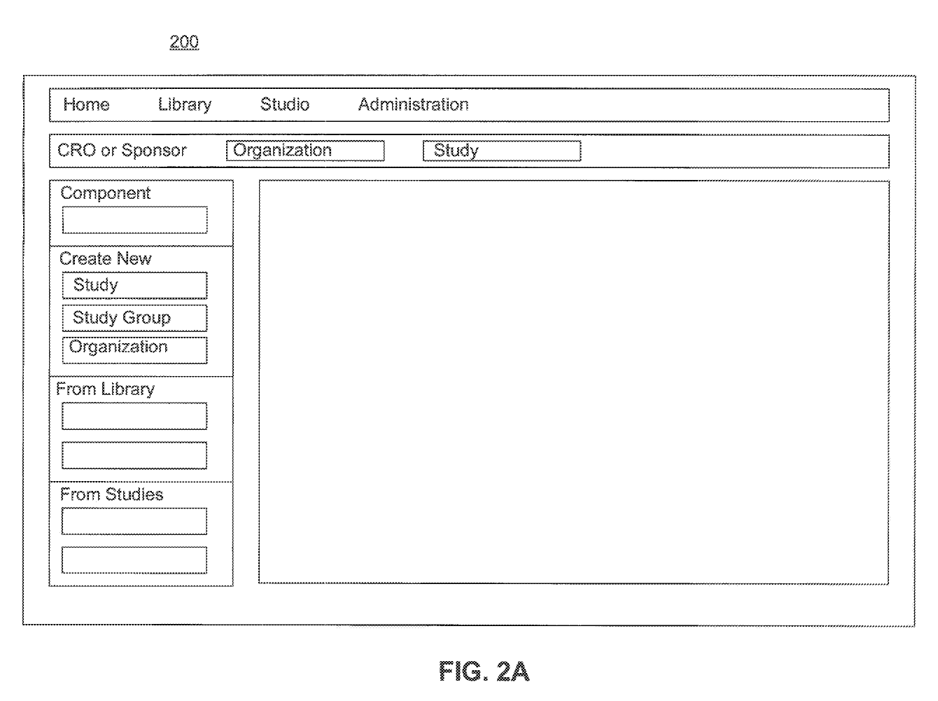

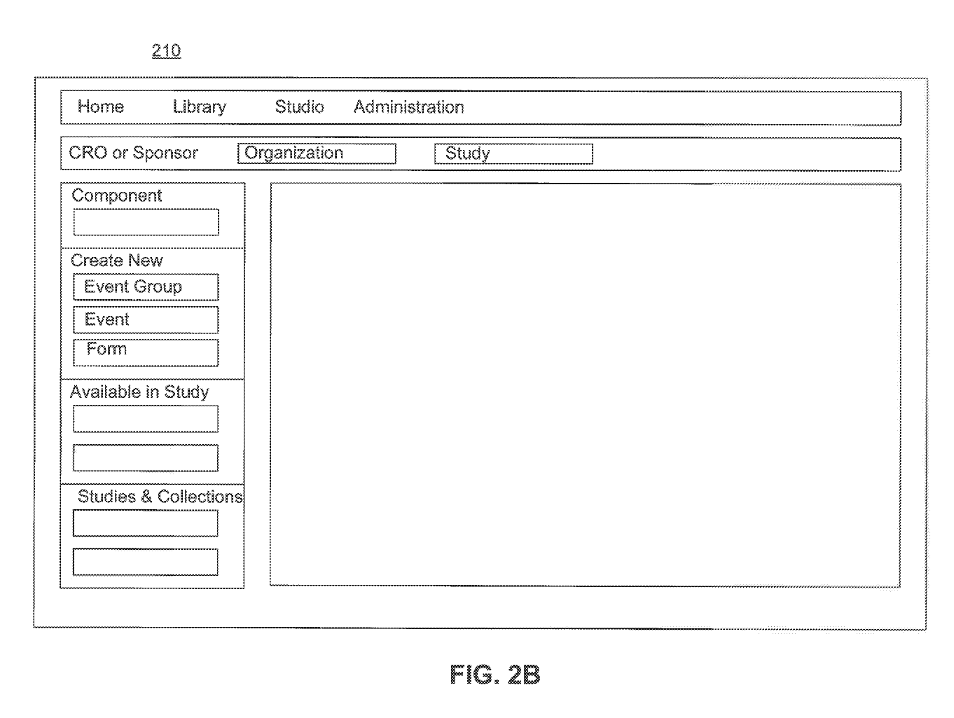

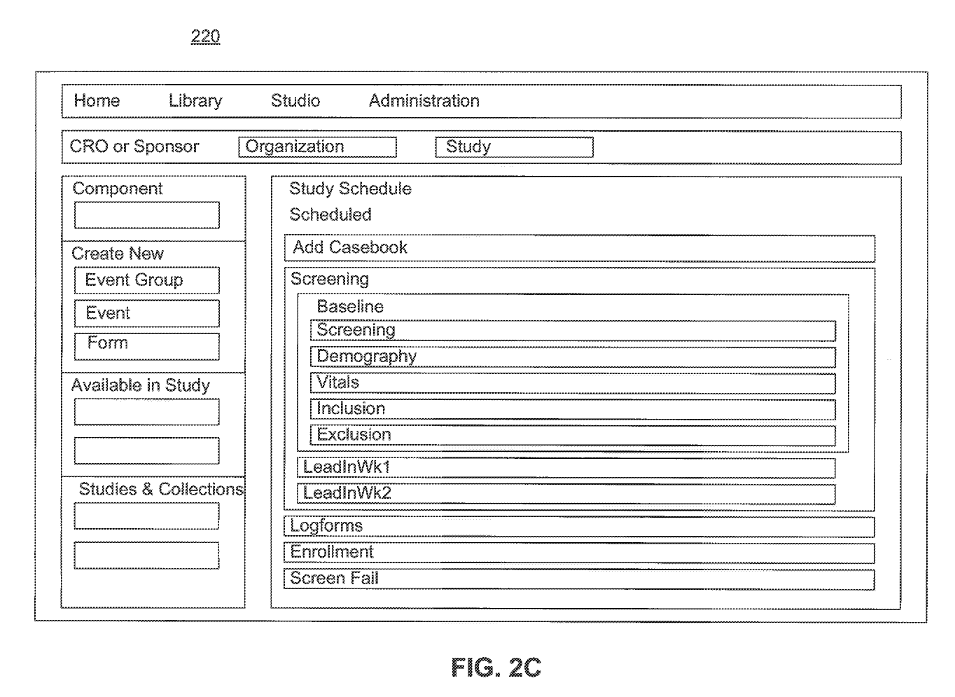

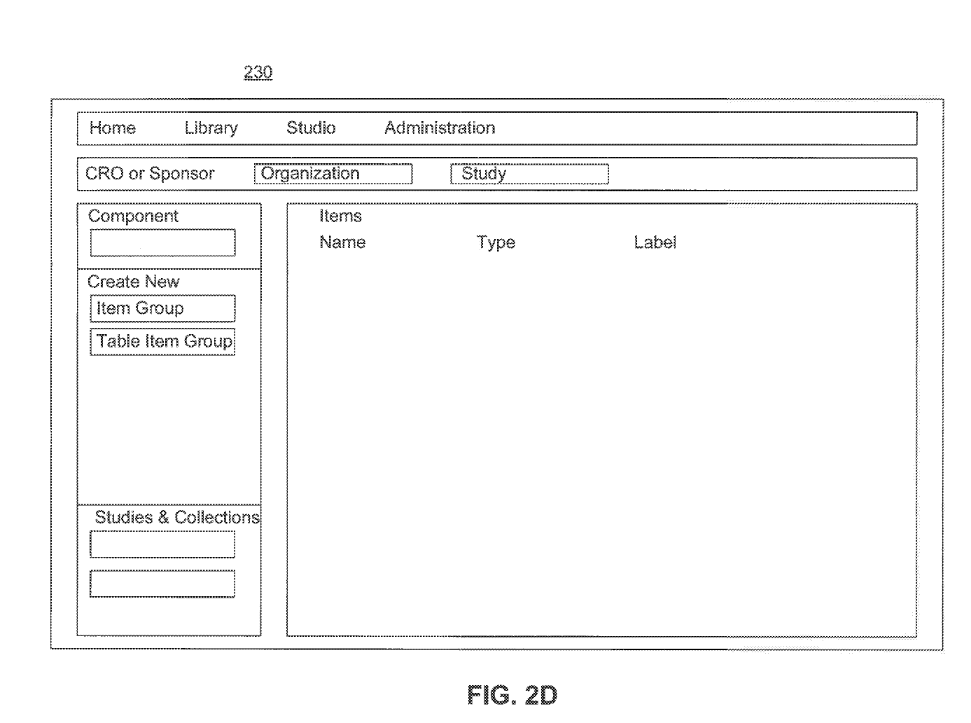

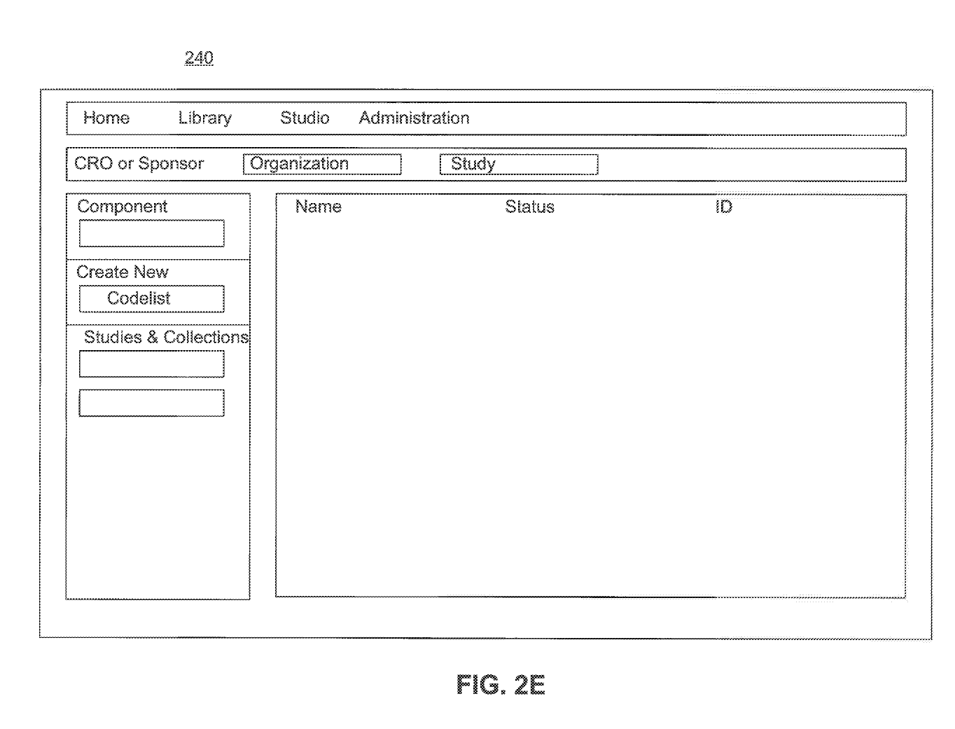

FIGS. 2A to 2E illustrate example user interfaces for creating or editing a study design according to one embodiment of the present invention. As shown, in response to a user input, the sponsor data management server 142 may present a user interface 200 in FIG. 2A for creating a new study, study group or organization; a user interface 210 in FIG. 2B for creating an event group, event or form; a user interface 220 in FIG. 2C for creating an object; a user interface 230 in FIG. 2D for creating an item group; and a user interface 240 shown in FIG. 2E for creating a codelist.

The study design may be stored in the sponsor data storage system 141 as objects. A few examples of the objects are described below:

1. FORM_DEF

FORM_DEF is the design object for all Forms.

| Field | Type | Description |
|---|---|---|
| id | System | Unique identifier for the record |
| name | System - | Name for the record |
| | Text 128 | |
| status | System - | Active vs. Inactive |
| | Picklist | |
| description | Text 255 | Description of the Form. |
| help_content | N/A | Stored in translation table. Hover text help text for the item. |
| prev_version | Object(form_def) | Self-Reference record when a version of the record is created. |
| | | Creates duplicate and duplicate points to the original |
| form_status | Picklist | Defines whether the item is published or in progress or |
| | | under review - Full list of picklist values contained in |
| | | table Data Types table. |
| scheduled | boolean | Boolean on whether the form is scheduled or unscheduled. |
| change_reason | Text 255 | Reason for change, if a change is made. |
| OID | Text 100 | ODM Id for loading in via ODM standards |
| pagelayout_xml | N/A | Defines that there will be a corresponding XML that |
| | | defines the layout of the Form. |
| label | N/A | Stored in translation table |
| study | Object | Reference to the study that is the context of the design. |
| | (study_v) | |

2. FORM_DEF_ITEMGROUP_DEF

FORM_DEF_ITEMGROUP_DEF is the design intersection object between Form and Item Group. It enables the system to understand what Sections should appear on a Form that is part of a visit.

| Field | Type | Description |
|---|---|---|
| id | System | Unique identifier for the record |
| name | System - | System generated autonumber |
| | Autonumber | |
| status | System - | Active vs. Inactive |
| | Picklist | |
| parent | Parent Object | Parent object of intersection record. |
| | (Form_Def) | |
| child | Parent Object | Second parent object of intersection record. |
| | (ItemGroup_Def) | |
| repeat_max | Number | Number of times a repeating question can be captured. |
| order_num | Number | Order number to display the Forms when recording an Event |
| change_reason | Text 255 | Reason for change, if a change is made. Trigger logic |
| | | on object to prevent a change if the status_vdc is |
| | | published and this field isn't populated on a change. |
| OID | Text 100 | ODM Id for loading in via ODM standards |
| mandatory | Boolean | Defines if the record is mandatory. |
| label | N/A | Stored in translation table |
| study | Object | Reference to the study that is the context of the design. |
| | (study_v) | |
| casebook_def | Object | Reference to the version of the Casebook_Def. |
| | (casebook_def) | |

3. EVENT_DEF

EVENT_DEF is the design object for events (visits). A visit will require that multiple forms be filled out.

| Field | Type | Description |
|---|---|---|
| id | System | Unique identifier for the record |
| name | System - | Name for the record |
| | Text 128 | |
| status | System - | Active vs. Inactive |
| | Picklist | |
| description | Text 255 | Description of the Event |
| event_status | picklist | Defines whether the item is published or in progress or |
| | | under review - Full list of picklist values contained in |
| | | table Data Types table. |
| help_content | N/A | Stored in translation table. Hover text help text for the item. |
| event_type | picklist | Type of event - Baseline, Visit 1, etc. |
| repeat_max | number | Number of times that an event can be repeated. Can be |
| | | used for unscheduled events and putting a cap on the |
| | | number of these. |
| prev_version | Object(event_def) | Self-Reference record when a version of the record is created. |
| | | Creates duplicate and duplicate points to the original |
| scheduled | boolean | Boolean on whether the event is scheduled or unscheduled. |
| change_reason | Text 255 | Reason for change, if a change is made. Trigger logic on |
| | | object to prevent a change if the status_vdc is published |
| | | and this field isn't populated on a change. |
| OID | Text 100 | ODM Id for loading in via ODM standards |
| label | N/A | Stored in translation table |
| study | Object | Reference to the study that is the context of the design. |
| | (study_v) | |

4. EVENT_DEF_FORM_DEF

It is the Design intersection object between Event and Form, and enables the system to understand what Forms should appear on a visit.

| Field | Type | Description |
|---|---|---|
| id | System | Unique identifier for the record |
| name | System - | System generated autonumber |
| | Autonumber | |
| status | System - | Active vs. Inactive |
| | Picklist | |
| parent | Parent Object | Parent object of interesection record. |
| | (Event_Def) | |
| child | Parent Object | Second parent object of intersection record. |
| | (Form_Def) | |
| change_reason | Text 255 | Reason for change, if a change is made. Trigger logic on |
| | | object to prevent a change if the status_vdc is published |
| | | and this field isn't populated on a change. |
| label | N/A | Stored in translation table |
| OID | Text 100 | ODM Id for loading in via ODM standards |
| mandatory | Boolean | Defines if the record is mandatory. |
| order_num | Number | Order number to display the Forms when recording an Event |
| repeat_max | Number | The limit that the form can be repeated for this event. |
| | | Null if there is no max. |
| study | Object | Reference to the study that is the context of the design. |
| | (study_v) | |
| casebook_def | Object | Reference to the version of the Casebook_Def. |
| | (casebook_def) | |

5. CASEBOOK_DEF

It is the design object for casebook, which is a set of visits that are expected to be used to collect information for a specific patient.

| Field | Type | Description |
|---|---|---|
| id | System | Unique identifier for the record |
| name | System - | Name for the record |
| | Text 128 | |
| status | System - | Active vs. Inactive |
| | Picklist | |
| description | Text 255 | Description of the Event |
| casebook_status | picklist | Defines whether the item is published or in progress |
| | | or under review - Full list of picklist values contained |
| | | in table Data Types table. |
| help_content | N/A | Stored in translation table. Hover text help text for the item. |
| casebook_type | picklist | Type of casebook |
| prev_version | Object(casebook_def) | Self-Reference record when a version of the record is created. |
| | | Creates duplicate and duplicate points to the original |
| change_reason | Text 255 | Reason for change, if a change is made. Trigger logic |
| | | on object to prevent a change if the status_vdc is |
| | | published and this field isn't populated on a change. |
| OID | Text 100 | ODM Id for loading in via ODM standards |
| label | N/A | Stored in translation table |
| study | Object | Reference to the study that is the context of the design. |
| | (study_v) | |

6. ITEM_[STUDYID]

It is the execution object. Stores the data that is captured. A separate ITEM Table will be created per Study.

| Field | Type | Description |
|---|---|---|
| id | System | Unique identifier for the record |
| name | System - | Name for the record. Copied from Item_Def. |
| | Text 128 | |
| status | System - | Active vs. Inactive |
| | Picklist | |
| itemgoup | Parent Object | Parent record |
| | (Itemgroup) | |
| item_def | Object | Relationship to the design record |
| | (Item_def) | |
| value | Text 1500 | Captured value |
| value_translated | Text 1500 | Translated value of the value |
| codelist_items_def | Object(codelist_items_def) | Reference to the design record for a selected |
| | | codelist item. |
| codelist_code | Text 100 | Codelist code that was selected |
| codelist_label | Text 255 | Codelist label (display) that was selected |
| unit_ref | Text 100 | Units Reference - Base Unit for translated value |
| unit_value | Text 100 | Units Value - Unit that was selected |
| rev_sdv | Boolean | Review for SDV |
| rev_sdr | Boolean | Review for SDR |
| rev_dmr | Boolean | Review for DMR |
| rev_sign | Boolean | Review for Signature |
| rev_frozen | Boolean | Review for Frozen |
| rev_locked | Boolean | Reivew for Locked |
| change_reason | Text 255 | Reason for change, if a change is made. |
| | | Trigger logic on object to prevent a change if |
| | | the status_vdc is published and this field |
| | | isn't populated on a change. |
| study | Object | Relationship to Study record. Copied down |
| | (Study_v) | for performance and query execution. |
| subject | Object | Relationship to Subject record. Copied down |
| | (Subject) | for performance and query execution. |
| site | Object | Relationship to Site record. Copied down for |
| | (Site_v) | performance and query execution |
| casebook | Object | Realatoinship to the Casebook record. |
| | (CaseBook_vdc) | Copied down for performance and query |
| | | execution. |
| item_status | Picklist | Current status of the Item - completed, in |
| | | progress, reviewed, verified |

7. ITEMGROUP

It is the execution object, and stores that a question was answered in a particular section (ItemGroup) and the section has a status.

| Field | Type | Description |
|---|---|---|
| id | System | Unique identifier for the record |
| name | System - | Name of the record. Copied from ItemGroup_Def. |
| | Text 128 | |
| status | System - | Active vs. Inactive |
| | Picklist | |
| itemgroup_status | picklist | Current status of the ItemGroup - completed, in |
| | | progress, reviewed, verified |
| form | Parent Object | Parent record |
| | (Form) | |
| itemgroup_seq | Number | Sequence of the Item Group in the case that it repeated |
| itemgroup_def | Object | Relationship to the design record |
| | (Itemgroup_def) | |
| repeat_key | Text | This is a unique identifier for a repeating item group |
| | | within a form (generally a table). This is related to |
| | | both itemgroup_seq_vdc and external ID. |
| rev_sdv | Boolean | Review for SDV. System maintained, field that is the |
| | | aggregate of all of the Items in the Item Group. |
| rev_sdr | Boolean | Review for SDR. System maintained field that is the |
| | | aggregate of all of the Items in the Item Group. |
| rev_dmr | Boolean | Review for DMR. System maintained field that is the |
| | | aggregate of all of the Items in the Item Group. |
| rev_sign | Boolean | Review for Signature. System maintained field that is |
| | | the aggregate of all of the Items in the Item Group. |
| rev_frozen | Boolean | Review for Frozen. System maintained field that is the |
| | | aggregate of all of the Items in the Item Group. |
| rev_locked | Boolean | Review for Locked. System maintained field that is |
| | | the aggregate of all of the Items in the Item Group. |
| study | Object | Relationship to Study record. Copied down for |
| | (Study_v) | performance and query execution. |
| subject | Object | Relationship to Subject record. Copied down for |
| | (Subject) | performance and query execution. |
| site | Object | Relationship to Site record. Copied down for |
| | (Site_v) | performance and query execution |
| casebook | Object | Realatoinship to the Casebook record. Copied down |
| | (CaseBook_vdc) | for performance and query execution. |
| change_reason | Text 255 | Reason for change, if a change is made. Trigger logic |
| | | on object to prevent a change if the status_vdc is |
| | | published and this field isn't populated on a change. |

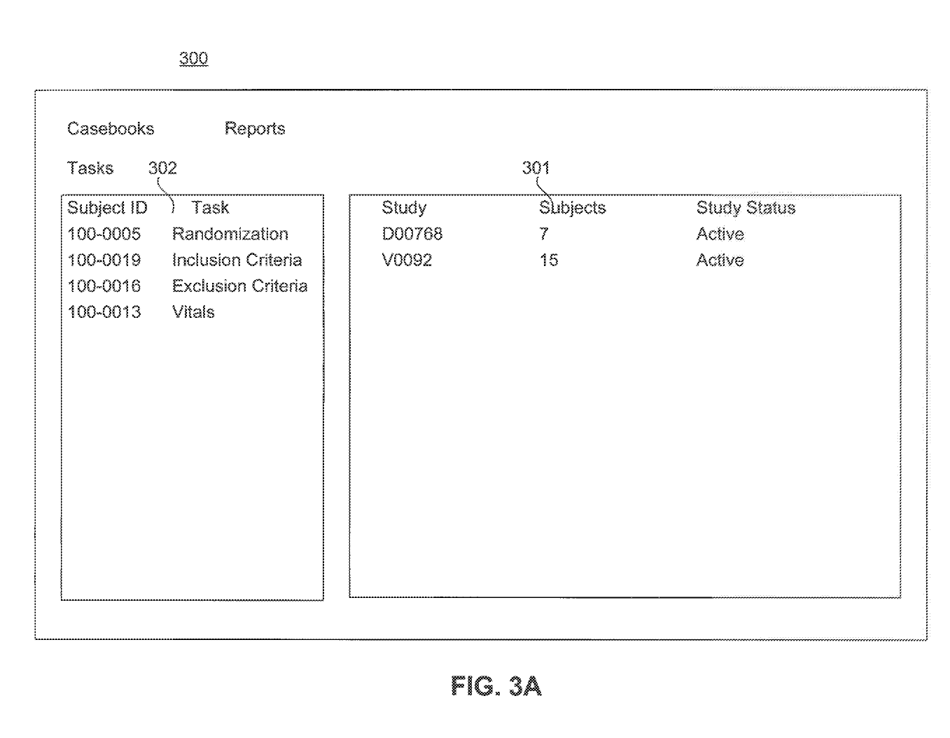

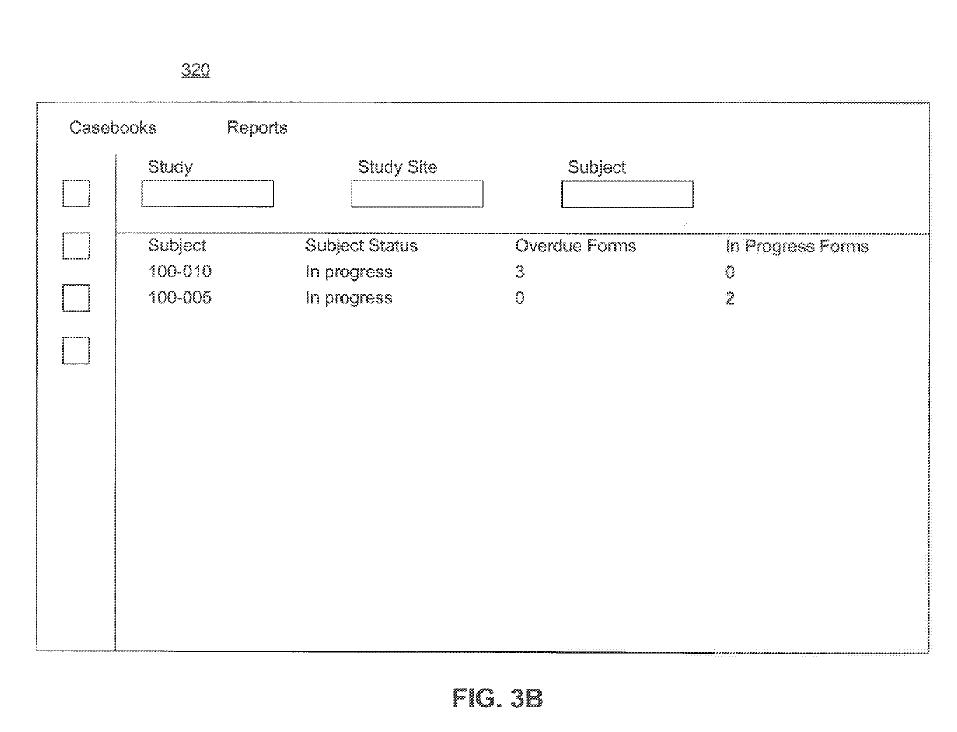

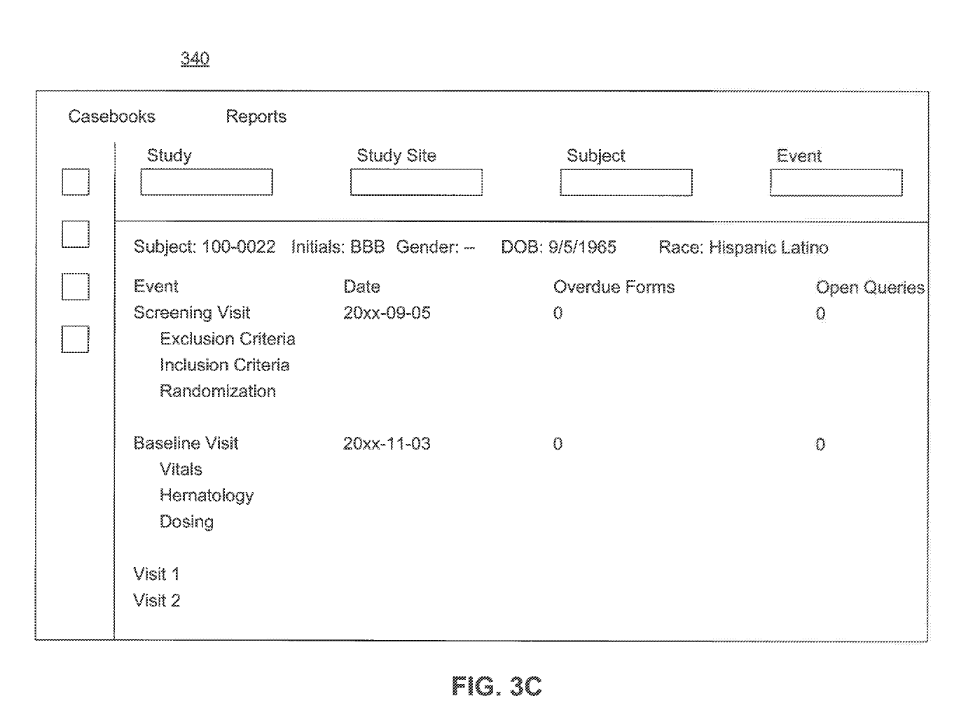

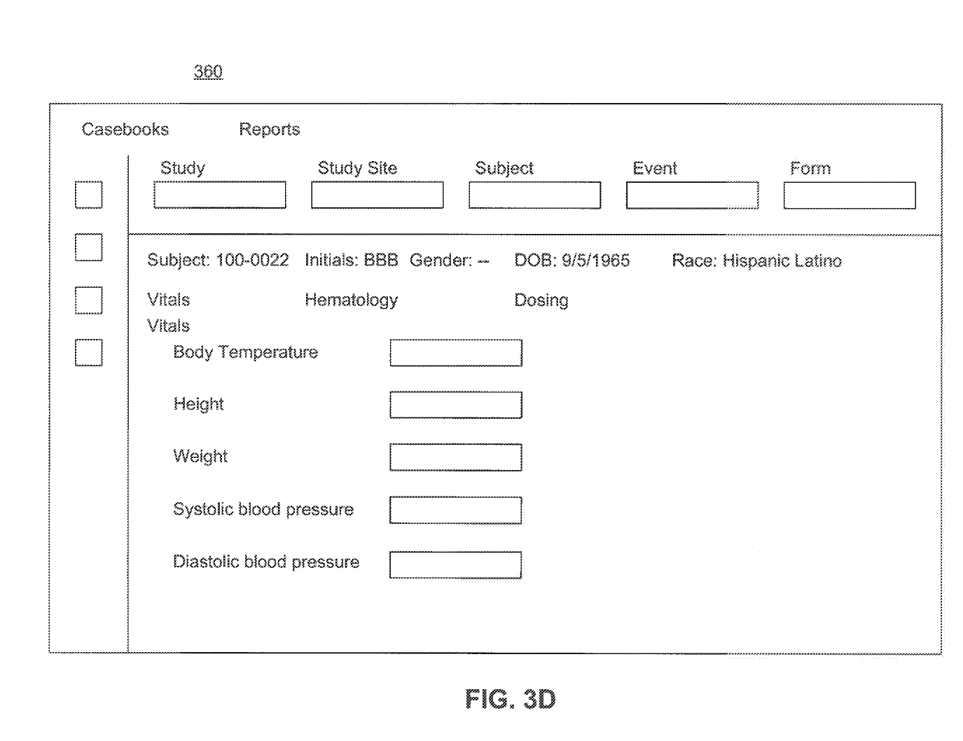

FIGS. 3A to 3D illustrate example user interfaces for collecting patient clinical trial information according to one embodiment of the present invention. During the execution stage of a clinical trial, when a clinical trial site user logs into the site data management system 130, a user interface 300 may be generated, e.g., based on one or more Objects of the definition of the first clinical trial and clinical trial source data previously stored in the medical data storage system 111. The user interface 300 may have an area 301 for displaying clinical trials the site user is working on, and an area 302 for displaying clinical trial tasks he/she needs to take action on, e.g., overdue forms and queries they need to respond to.

When the site user selects a clinical trial, a user interface 320 shown in FIG. 3B may be displayed, which may have a list of the subjects of the clinical trial, and their status, including overdue forms and in progress forms.

When the site user selects a subject, a user interface 340 shown in FIG. 3C may be displayed, which may have some biographic information the subject provided (e.g., date of birth, gender and race), a list of all his/her visits, and forms that have been filled out. The subjects may come in on a regular basis, and receive their medication. It may take a measurement on how they are performing as part of the clinical trial. The data will be aggregated up to determine if the product is effective and safe.

When the site user starts or selects a visit, a user interface 360 shown in FIG. 3D may be displayed. The clinical trial site user may enter data on the user interface 360. For example, based upon the information just captured, the clinical site user may put into the vital forms 98.6° F. for temperature, 72 for height, and 200 for weight. When there is Internet access, the data may be sent to the site data storage system 131, and a little icon may show up to indicate that the data is stored in real time. In one embodiment, the clinical trial source data may be checked for obvious mistakes, e.g., data in a wrong field, and data out of reasonable range. The data validation may be done at the medical data management system 110. Once the site user submits the form, the information becomes locked. Alternatively, the data validation may be done at the site management server 132.

The clinical trial site user may navigate through the user interfaces, and go to any point in the hierarchy and any subject in the study. The site user may fill out the information, and go to the next subject, without having to change the context and the event in the form that he/she is filling out.

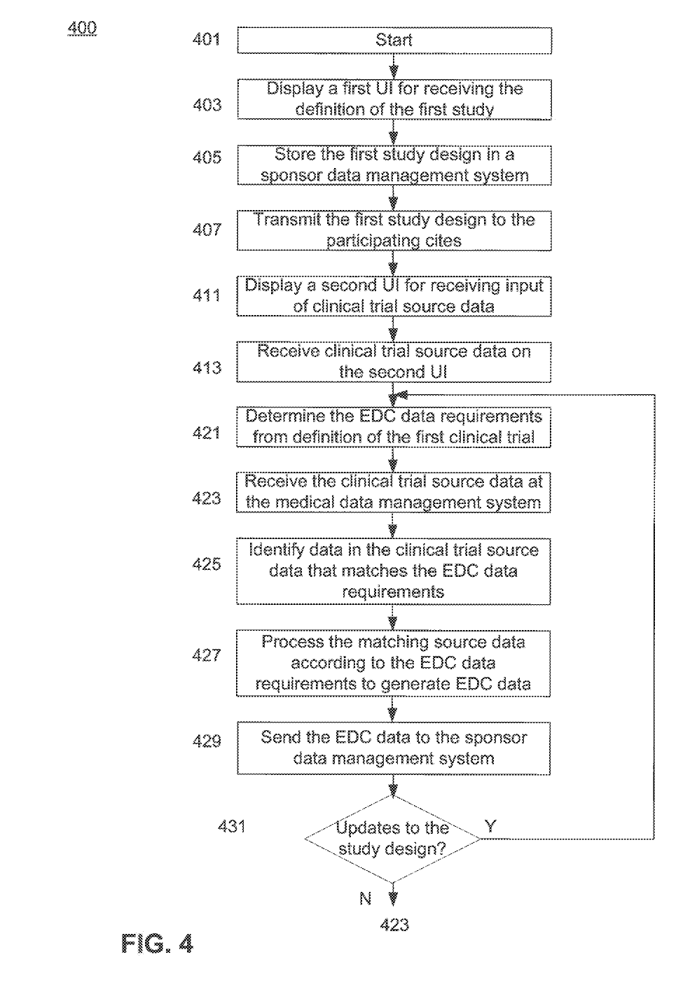

FIG. 4 illustrates a flowchart of a method for collecting medical data according to one embodiment of the present invention.

The process may start at 401.

At 403, a user interface, e.g., the user interface 200 shown in FIG. 2A, may be displayed for accepting definition of a first study design from a sponsor user.

At 405, the first study design may be received from the user computing device 120b and stored in the sponsor data storage system 141. In one example, the study is to monitor blood pressure response to a medication, and may require a number of visits according to a predetermined schedule and a blood pressure value for each visit.

At 407, the first study design may be published and transmitted to sites involved through the medical data management system 110. In one implementation, the study design may be stored in, e.g., the site data storage system 131 for the first participating site and the site data storage system 151 for the second participating site. In one example, the site data management systems 130 and 150 may be authenticated before the first design study can be transmitted to them.

At 411, a clinical trial site user may log in, and user interfaces 300, 320, 340 and 360 may be displayed while he/she is navigating through the webpages to select the study, subject, event and form.

At 413, medical data may be entered on a user interface, e.g., the user interface 360 shown in FIG. 3D, via the user computing device 120a and stored in the site data storage system 131 as clinical trial source data. Medical data may also be entered to another user computing device and stored in the site data storage system 151 as clinical trial source data. In one example, during execution of the study on a site, a patient's blood pressure may be taken three times during a visit and stored in the site data storage system 131 as clinical trial source data.

At 421, the medical data management system 110 may determine the EDC data requirements of the first clinical trial (e.g., a patient's blood pressure values over six weeks, with three values each week, and each value is the average of three measurements taken during one visit) from the definition of the first clinical trial.

At 423, the medical data management system 110 may receive clinical trial source data from a site data management system (e.g., 130). The source data may be in XML, Excel, text, JSON, data in a database table or other formats.

At 425, the medical data management system 110 may identify the corresponding data in the clinical trial source data that is required by the EDC data requirements, e.g., three measurements taken during one visit. In one implementation, the medical data management system 110 may match or map the clinical trial source data and the EDC data requirements by checking the ID or name of a record.

At 427, the medical data management system 110 may process the clinical trial source data according to the EDC data requirements to get the EDC data. In one example, the three blood pressure values may be averaged up to get the EDC data. In one implementation, the clinical trial source data may be obfuscated to remove patient defining information to get the EDC data.

At 429, the EDC data may be sent from the medical data management system 110 to the sponsor data management system 140 and stored in the sponsor data storage system 141 as the EDC data.

At 431, it may be determined by the medical data management system 110 if there are any updates to the first study design. If yes, the process may return to 407 for transmitting updates to the first study design. Otherwise, the process may return to 415 to receive additional clinical trial source data.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, hut are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

What is claimed is:

1. A computer-implemented method for collecting medical data, the method comprising:
receiving a definition of a first clinical trial from a sponsor data management system, wherein the definition of the first clinical trial defines requirements and a workflow of the first clinical trial, and wherein the workflow of the first clinical trial defines forms to be filled out and measurements to be taken during a visit;
receiving clinical trial source data from a site data management system, wherein the clinical trial source data is collected according to the definition of the first clinical trial;
determining EDC data requirements in the definition of the first clinical trial, including required source data for generating the EDC data, wherein the EDC data requirements comprise a measurement to be taken, a frequency to take the measurement, and how to calculate the EDC data;
identifying data in the clinical trial source data that matches the required source data; and
processing the matching source data according to the EDC data requirements to generate the EDC data.

2. The method of claim 1, further comprising: sending the EDC data to the sponsor data management system.

3. The method of claim 1, wherein the matching source data is identified by checking a record's ID.

4. The method of claim 1, wherein the matching source data is identified by checking a record's name.

5. The method of claim 1, further comprising: aggregating the matching source data to obtain the EDC data.

6. The method of claim 1, further comprising: obfuscating the matching source data to obtain the EDC data.

7. The method of claim 1, further comprising: receiving updates to the definition of the first clinical trial from the sponsor data management system and forwarding to the site data management system.

8. A medical data management system, comprising:
a medical data processing unit for:
receiving a definition of a first clinical trial from a sponsor data management system, wherein the definition of the first clinical trial defines requirements and a workflow of the first clinical trial, and wherein the workflow of the first clinical trial defines forms to be filled out and measurements to be taken during a visit;
receiving clinical trial source data from a site data management system, wherein the clinical trial source data is collected according to the definition of the first clinical trial;
determining EDC data requirements in the definition of the first clinical trial, including required source data for generating the EDC data, wherein the EDC data requirements comprise a measurement to be taken, a frequency to take the measurement, and how to calculate the EDC data;
identifying data in the clinical trial source data that matches the required source data; and
processing the matching source data according to the EDC data requirements to generate the EDC data.

9. The system of claim 8, wherein the medical data processing unit further sends the EDC data to the sponsor data management system.

10. The system of claim 8, wherein the matching source data is identified by checking a record's ID.

11. The system of claim 8, wherein the matching source data is identified by checking a record's name.

12. The system of claim 8, wherein the medical data processing unit further aggregates the matching source data to obtain the EDC data.

13. The system of claim 8, wherein the medical data processing unit farther obfuscates the matching source data to obtain the EDC data.

14. The system of claim 8, wherein the medical data processing unit further receives updates to the definition of the first clinical trial from the sponsor data management system and forwarding to the site data management system.

15. The system of claim 8, being a middleware layer.

16. The system of claim 8, being an integration engine.
